(19) United States
(12) Patent Application Publication
(10) Pub. No.: US 2009/0218248 A1
(43) Pub. Date: Sep. 3, 2009

(54) APPARATUS, SYSTEM, AND METHOD FOR PROTECTING A PRODUCT

(76) Inventors: Ivan Neil Liverman, Middlesex, NC (US); Christopher John Sattora, Cary, NC (US); Eric Allen Stegner, Durham, NC (US); Robert William Stegner, Raleigh, NC (US)

Correspondence Address: Kunzler & McKenzie, 8 EAST BROADWAY, SUITE 600, SALT LAKE CITY, UT, 84111, US

(21) Appl. No.: 12/040,483

(22) Filed: Feb. 29, 2008

(51) Int. Cl. B65D 81/107; B65D 25/10; B26D 3/00; B26D 7/00

(52) U.S. Cl. 206/523; 83/23; 83/39

(57) ABSTRACT

An apparatus, system, and method are disclosed for protecting a product. A center member is in physical communication with a bottom of the product. North, south, east, and west members are in communication with the center member and each comprise an orifice. In addition, the north, south, east, and west members are partially separated from the center member by proximal cuts along a lower side of the sheet. The north, south, east, and west members are configured to pivot upward to form at least a ninety degree angle to the center member and physically communicate with sides of the product. The east and west members further comprise distal cuts about which east and west distal edges pivot toward the center member such that the east and west distal edges are in physical communication with a top of the product when folded.

### BACKGROUND OF THE INVENTION

1. Field of the Invention

This invention relates to protecting a product and more particularly relates to protecting a packaged product.

2. Description of the Related Art

Products such as electronic devices are typically packaged for shipment. A product may be surrounded by cushioning materials and placed inside a container. The cushioning materials may protect the product during shipment.

The cushioning materials typically include a plurality of discrete cushions. For example, electronic device may be protected by two cushions. A first cushion may protect an east side of the product, a portion of a north side of the product, a portion of a south side of the product, a portion of a top of the product, and a portion of the bottom of the product. In addition, a second cushion may protect a west side a product, a portion of the north side of the product, a portion of the south side of the product, and a portion of the bottom of the product. As used herein, north, south, east, and west are used to refer to sides of a product, and do not refer to geophysical directions.

Alternatively, the first cushion may be configured as an open box. The product may be placed within the first cushion. In addition, the second cushion configured as a lid may be placed over the product to complete the protection of the product.

Unfortunately, using multiple cushions to protect the product increases the difficulty of stocking and using protective material. For example, if two cushions are used for a hard disk drive, each cushion must be ordered, stocked, and placed in production.

### SUMMARY OF THE INVENTION

From the foregoing discussion, there is a need for an apparatus, system, and method that protect a product. Beneficially, such an apparatus, system, and method would protect the product on all sides using a single cushion.

The present invention has been developed in response to the present state of the art, and in particular, in response to the problems and needs in the art that have not yet been fully solved by currently available product protection methods. Accordingly, the present invention has been developed to provide an apparatus, system, and method for protecting a product that overcome many or all of the above-discussed shortcomings in the art.

The apparatus to protect a product is provided with a single planar foam sheet. The foam sheet includes a center member, a north member, a south member, an east member, and a west member.

The center member is in physical communication with a bottom of the product. The north member is in communication with the center member and comprises a north orifice. In addition, the north member is partially separated from the center member by a north proximal cut along a lower side of the sheet. The north member is configured to pivot upward to form at least a ninety degree angle to the center member and physically communicate with a north side of the product.

The south member is in communication with the center member and comprises a south orifice. In addition, the south member is partially separated from the center member by a south proximal cut along the lower side of the sheet. The south member is configured to pivot upward to form at least a ninety degree angle to the center member and physically communicate with a south side of the product.

The east member is in communication with the center member and comprises an east orifice. In addition, the east member is partially separated from the center member by an east proximal cut along the lower side of the sheet. The east member is configured to pivot upward to form at least a ninety degree angle to the center member and physically communicate with an east side of the product. The east member further comprises an east distal cut that partially separates an east distal edge from the east member and permits the east distal edge to pivot toward the center member such that the east distal edge is in physical communication with a top of the product when folded.

The west member is in communication with the center member and comprises a west orifice. In addition, the west member is partially separated from the center member by a west proximal cut along the lower side of the sheet. The west member is configured to pivot upward to form at least a ninety degree angle to the center member and physically communicate with a west side of the product. The west member further comprises a west distal cut that partially separates a west distal edge from the west member and permits the west distal edge to pivot toward the center member such that the west distal edge is in physical communication with the top of the product when folded.

A system of the present invention. The system may be embodied in a packaging system. In particular, the system, in one embodiment, includes a container and a foam cushion. The foam cushion is fabricated from a single planar sheet and includes a center member, a north member, a south member, and east member, and a west member.

The center member is in physical communication with a bottom of the product. The north member is in communication with the center member and comprises a north orifice. In addition, the north member is partially separated from the center member by a north proximal cut along a lower side of the sheet. The north member is configured to pivot upward to form at least a ninety degree angle to the center member and physically communicate with a north side of the product.

The south member is in communication with the center member and comprises a south orifice. In addition, the south member is partially separated from the center member by a south proximal cut along the lower side of the sheet. The south member is configured to pivot upward to form at least a ninety degree angle to the center member and physically communicate with a south side of the product.

The east member is in communication with the center member and comprises an east orifice. In addition, the east member is partially separated from the center member by an east proximal cut along the lower side of the sheet. The east member is configured to pivot upward to form at least a ninety degree angle to the center member and physically communicate with an east side of the product. The east member further comprises an east distal cut that partially separates an east distal edge from the east member and permits the east distal edge to pivot toward the center member such that the east distal edge is in physical communication with a top of the product when folded.

The west member is in communication with the center member and comprises a west orifice. In addition, the west member is partially separated from the center member by a west proximal cut along the lower side of the sheet. The west member is configured to pivot upward to form at least a ninety degree angle to the center member and physically communicate with a west side of the product. The west member further comprises a west distal cut that partially separates a west distal edge from the west member and permits the west distal edge to pivot toward the center member such that the west distal edge is in physical communication with the top of the product when folded. The foam cushion and product are disposed within the container.

A method of the present invention is also presented for protecting a product. The method in the disclosed embodiments substantially includes the steps to carry out the functions presented above with respect to the operation of the described apparatus and system.

A stamp stamps a center member from a polyethylene sheet, the center member is in physical communication with a bottom of the product, a north member in communication with the center member, a south member in communication with the center member, an east member in communication with the center member, and a west member in communication with the center member. In addition, the stamp stamps a north orifice in the north member, a south orifice in the south member, an east orifice in the east member, and a west orifice in the west member.

The stamp further stamps a north proximal cut along a lower side of the sheet wherein the north member is partially separated from the center member and is configured to pivot upward to form at least a ninety degree angle to the center member and physically communicate with a north side of the product, a south proximal cut along the lower side of the sheet wherein the south member is partially separated from the center member and is configured to pivot upward to form at least a ninety degree angle to the center member and physically communicate with a south side of the product, an east proximal cut along the lower side of the sheet wherein the east member is partially separated from the center member and is configured to pivot upward to form at least a ninety degree angle to the center member and physically communicate with an east side of the product, and a west proximal cut along the lower side of the sheet wherein the west member is partially separated from the center member and is configured to pivot upward to form at least a ninety degree angle to the center member and physically communicate with a west side of the product. In addition, the stamp stamps an east distal cut in the east member that partially separates an east distal edge from the east member and permits the east distal edge to pivot toward the center member such that the east distal edge is in physical communication with a top of the product when folded and a west distal cut in the west member that partially separates a west distal edge from the west member and permits the west distal edge to pivot toward the center member such that the west distal edge is in physical communication with the top of the product when folded. A packaging device and/or production worker may fold the north, south, east, and west members about the product to protect the product in a container.

References throughout this specification to features, advantages, or similar language do not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The present invention protects a product on all sides using a single cushion. In addition, the present invention may reduce the number of cushions required to protect a product. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a top view drawing illustrating one embodiment of a protection apparatus in accordance with the present invention;

FIG. 2 is a top view drawing illustrating one embodiment of an alternate protection apparatus of the present invention;

FIG. 3 is a top view drawing illustrating one alternate embodiment of a protection apparatus of the present invention;

FIG. 4 is a perspective drawing illustrating one embodiment of a protected product of the present invention;

FIG. 5 is a perspective drawing illustrating one embodiment of a protected product in a carton of the present invention; and

FIG. 6 is a schematic flow chart diagram illustrating one embodiment of a protection method of the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

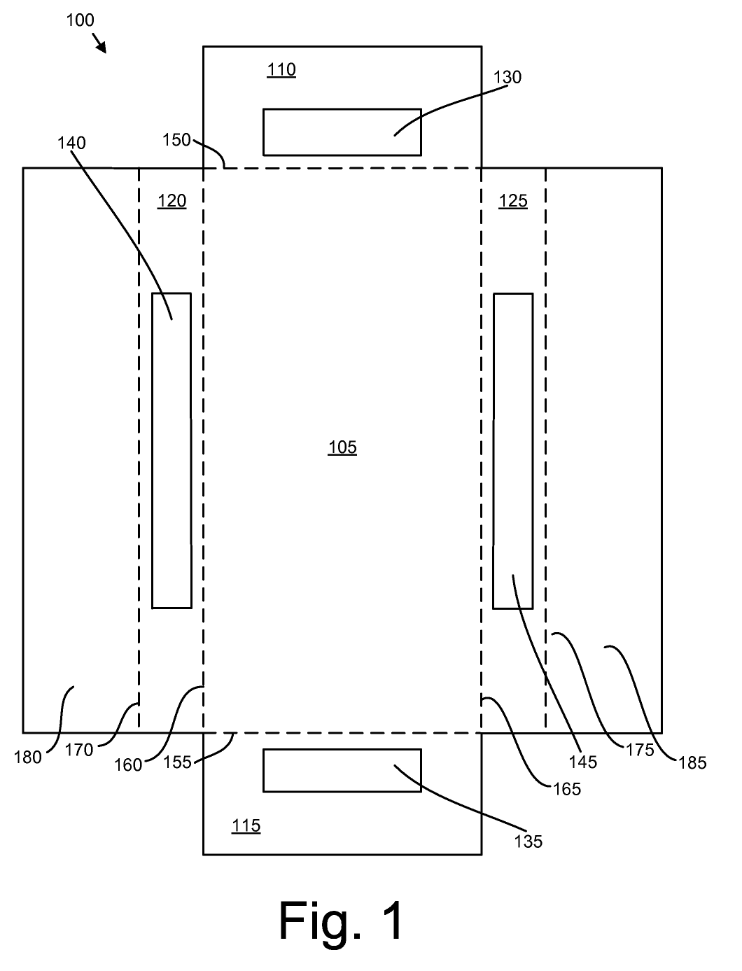

FIG. 1 is a schematic block diagram illustrating one embodiment of a protection apparatus 100 in accordance with the present invention. The apparatus 100 may be stamped from a single planar foam sheet. The foam sheet may be polyethylene foam cushion. The foam sheet includes a center member 105, a north member 110, a south member 115, an east member 120, and a west member 125.

The center member 105 is in physical communication with a bottom of the product (not shown). The north member 110 is in communication with the center member 105 and comprises a north orifice 130. In addition, the north member 110 is partially separated from the center member 105 by a north proximal cut 150 along a lower side of the sheet. The north member 110 is configured to pivot upward to form at least a ninety degree angle to the center member 105 and physically communicate with a north side of the product.

The south member 115 is in communication with the center member 105 and comprises a south orifice 135. In addition, the south member 115 is partially separated from the center member 105 by a south proximal cut 155 along the lower side of the sheet. The south member 115 is configured to pivot upward to form at least a ninety degree angle to the center member 105 and physically communicate with a south side of the product.

The east member 120 is in communication with the center member 105 and comprises an east orifice 140. In addition, the east member 120 is partially separated from the center member by an east proximal cut 160 along the lower side of the sheet. The east member 120 is configured to pivot upward to form at least a ninety degree angle to the center member 105 and physically communicate with an east side of the product. The east member 120 further comprises an east distal cut 170 that partially separates an east distal edge 180 from the east member 120 and permits the east distal edge 180 to pivot toward the center member 105 such that the east distal edge 180 is in physical communication with a top of the product when folded.

The west member 125 is in communication with the center member 105 and comprises a west orifice 140. In addition, the west member 140 is partially separated from the center member 105 by a west proximal cut 165 along the lower side of the sheet. The west member 125 is configured to pivot upward to form at least a ninety degree angle to the center member 105 and physically communicate with a west side of the product. The west member 125 further comprises a west distal cut 175 that partially separates a west distal edge 185 from the west member 125 and permits the west distal edge 185 to pivot toward the center member 105 such that the west distal edge 185 is in physical communication with the top of the product when folded.

In one embodiment, the north orifice 130, south orifice 135, east orifice 140, and west orifice 145 may relieve pressure on the product. For example, a carton may transfer pressure to the apparatus 100, and the apparatus 100 may transfer the pressure to the product. The orifices 130, 135, 140, 145 may reduce the transfer of pressure to the product.

In a certain embodiment, the north orifice 130, south orifice 135, east orifice 140, and west orifice 145 each are cut from an area in the range of fifteen percent to forty percent (15%-40%) of an area of the north member 110, south member 115, east member 120, and west member 125 respectively. Alternatively, the north orifice 130, south orifice 135, east orifice 140, and west orifice 145 may be configured so that the north member 110, south member 115, east member 120, and west member 125 contact in the range of fifteen to eighty-five percent (15%-85%) of the north side of the product, the south side of the product, the east side of the product, and the west side of the product respectively.

The product may be placed upon the center member 105 and the north member 110, south member 115, east member 120, and west member 125 folded around the product as will be described hereafter. The apparatus 100 thus protects the product on all sides, while the apparatus 100 may be ordered, stocked, transported, and employed as a single unit.

In one embodiment, a distance from the east proximal cut 160 to the east distal cut 170 is substantially equivalent to a height of the east side of the product and a distance from the west proximal cut 165 to the west distal cut 175 is substantially equivalent to a height of the west side of the product. As used herein, substantially equivalence is within plus or minus five percent (±5%).

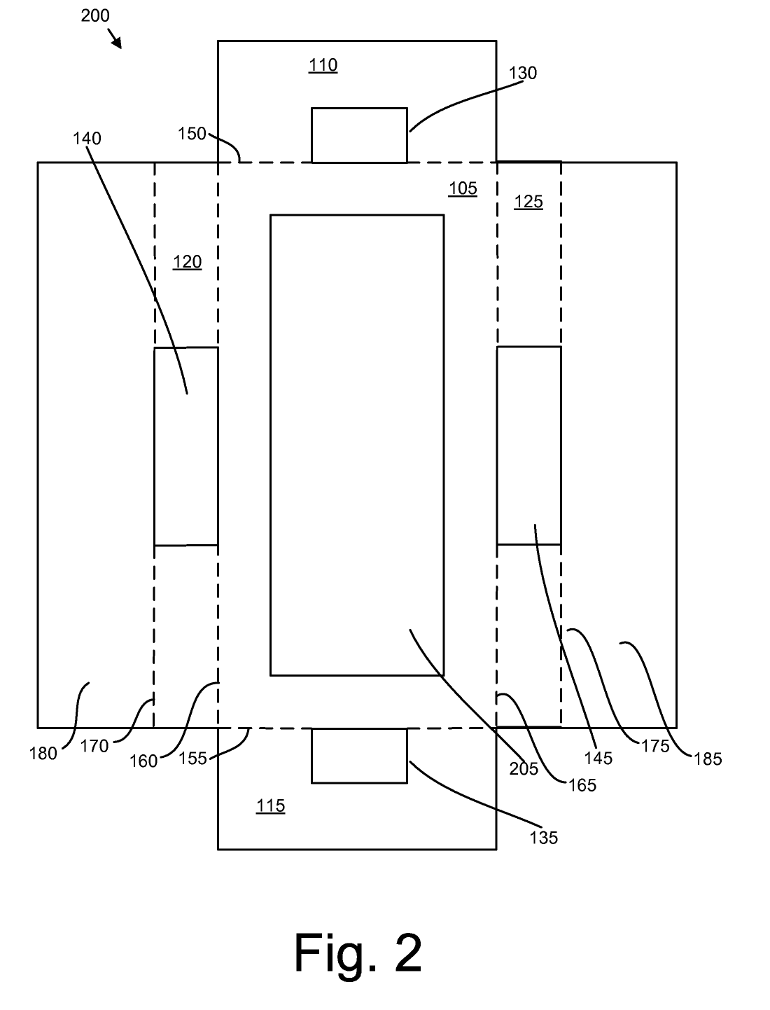

FIG. 2 is a schematic block diagram illustrating one embodiment of an alternate protection apparatus 200 of the present invention. The apparatus 200 includes the center member 105, north member 110, south member 115, east member 120, west member 125, north orifice 130, south orifice 135, east orifice 140, west orifice 145, north proximal cut 150, south proximal cut 155, east proximal cut 160, west proximal cut 165, east distal cut 170, west distal cut 175, east distal edge 180, and west distal edge 185 of FIG. 1.

The apparatus 200 further includes a center orifice 205. In one embodiment, the center orifice 205 is cut from an area in the range of fifteen percent to forty percent (15%-40%) of an area of the center member 105. Alternatively, the center orifice 205 may be configured so that the center member 105 contacts in the range of fifteen to eighty-five percent (15%-85%) of the bottom of the product.

In the depicted embodiment, the north orifice 130, south orifice 135, east orifice 140, and west orifice 145 each extend outward from the center member 105. For example, the north orifice 130, south orifice 135, east orifice 140, and west orifice 145 may each begin at the north proximal cut 150, the south proximal cut 155, the east proximal cut 160, and the west proximal cut 165 respectively.

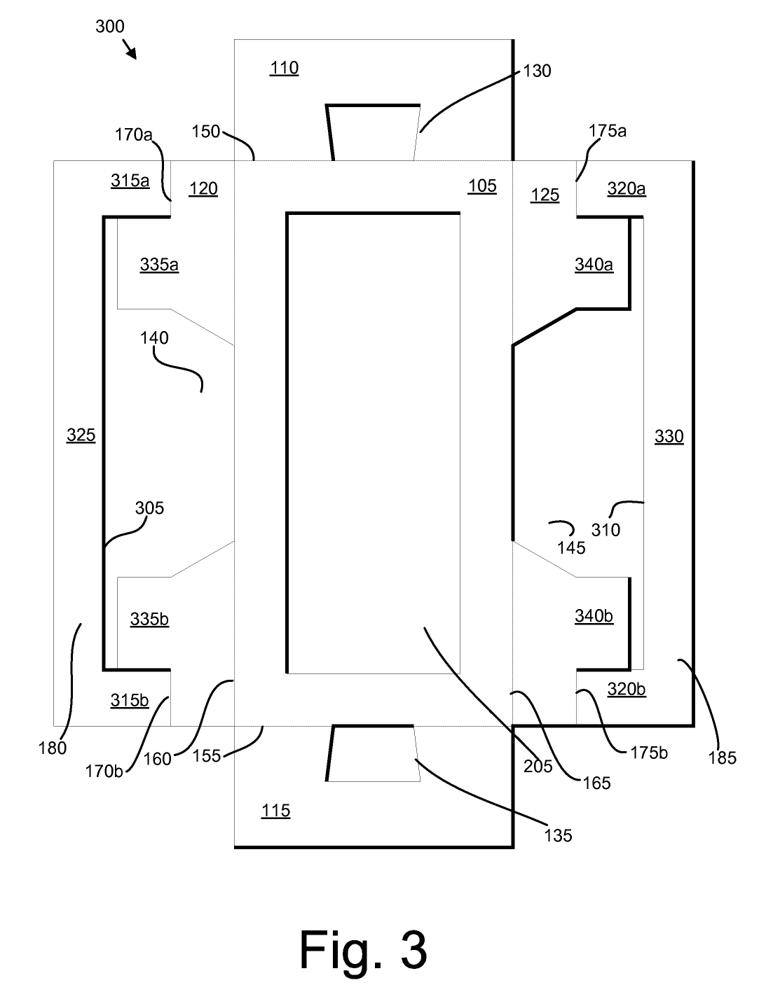

FIG. 3 is a schematic block diagram illustrating one alternate embodiment of a protection apparatus 300 of the present invention. The apparatus 300 includes the center member 105, north member 110, south member 115, east member 120, west member 125, north orifice 130, south orifice 135, east orifice 140, west orifice 145, north proximal cut 150, south proximal cut 155, east proximal cut 160, west proximal cut 165, east distal cut 170, west distal cut 175, east distal edge 180, and west distal edge 185 of FIG. 2.

In the depicted embodiment, the east distal cut 170 comprises a north east distal cut 170a and a south east distal cut 170b and the east member 120 further comprises an east divisional cut 305 that separates the east distal edge 180 from the east member 120 between the north east distal cut 170a and the south east distal cut 170b.

In addition, the west distal cut 175 is depicted comprising a north west distal cut 175a and a south west distal cut 175b and the west member 125 further comprises a west divisional cut 310 that separates the west distal edge 185 from the west member 120 between the north west distal cut 175a and the south west distal cut 175b.

In the depicted embodiment, the east distal edge 180 comprises a south east edge pivot 315b extending east from the south east distal cut 170b, a north east edge pivot 315a extending east from the north distal cut 170a, and an east cross member 325 physically communicating between the south east edge pivot 315b and the north east edge pivot 315a, wherein the east divisional cut 305 extends east from a terminus of the south east distal cut 170b to the east cross member 325, north along the east cross member 325, and west to a terminus of the north east distal cut 170a.

In addition, the west distal edge 185 comprises a south west edge pivot 320b extending west from the south west distal cut 175b, a north west edge pivot 320a extending west from the north distal cut 175a, and a west cross member 330 physically communicating between the south west edge pivot 320b and the north west edge pivot 320a, wherein the west divisional cut 310 extends west from a terminus of the south west distal cut 175b to the west cross member 330, north along the west cross member 330, and west to a terminus of the north west distal cut 175a.

In the depicted embodiment, the east member 120 further comprises a north east post 335a disposed between the east orifice 140 and the east divisional cut 305 and a south east post 335b disposed between the east orifice 140 and the east divisional cut 305, wherein a distal end of the north east post 335a and a distal end of the south east post 335b are each coplanar with a face of the east distal edge 180 when folded.

In addition, the west member 125 further comprises a north west post 340a disposed between the west orifice 145 and the west divisional cut 310 and a south west post 340b disposed between the west orifice 140 and the west divisional cut 310, wherein a distal end of the north west post 340a and a distal end of the south west post 340b are each coplanar with a face of the west distal edge 185 when folded.

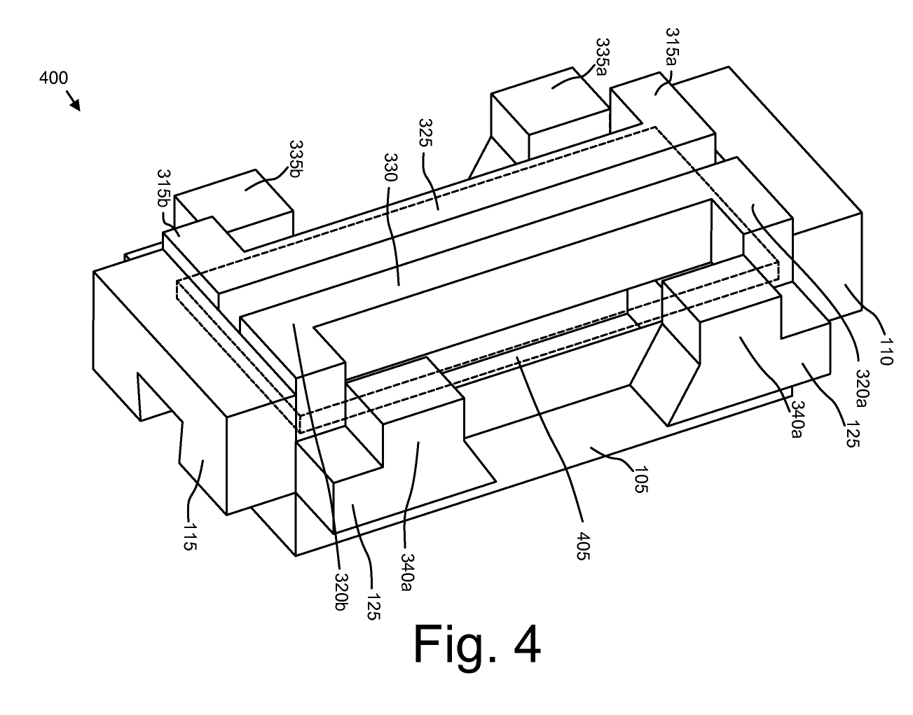

FIG. 4 is a perspective drawing illustrating one embodiment of a protected product 400 of the present invention. A product 405 is depicted surrounded by the folded apparatus 300 of FIG. 3. The center member 105, north member 110, south member 115, west member 125, north east edge pivot 315a, south east edge pivot 315b, north east post 335a, south east post 335b, north west edge pivot 320a, south west edge pivot 320b, north west post 340a, south west post 340b, east cross member 325, and west cross member 330 of FIG. 3 are shown positioned around the product 405.

The apparatus 300 folds to surround the product 405. The product 405 is protected on all sides by the apparatus 300.

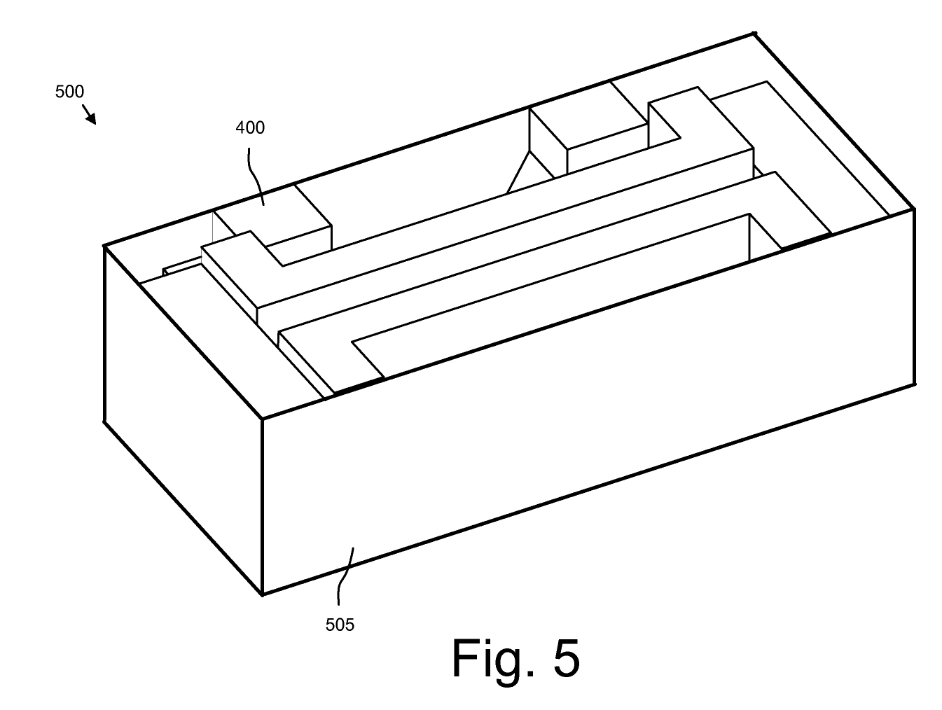

FIG. 5 is a perspective drawing illustrating one embodiment of a protected product in a carton 500 of the present invention. The protected product 400 of FIG. 4 is shown within a carton 505. In one embodiment, the apparatus 300 is placed within the carton 505, the product 405 is placed within the carton on the apparatus 300, and the apparatus 300 is folded about the product 405. Alternatively, the apparatus 300 may be folded about the product 405 and the apparatus 300/product 405 placed within the carton 505.

The product 405 and apparatus 300 may be positioned within the carton 505 by an automated packaging device. Alternatively, a production worker may place the product 405 and apparatus 300 within the carton 505.

The schematic flow chart diagrams that follow are generally set forth as logical flow chart diagrams. As such, the depicted order and labeled steps are indicative of one embodiment of the presented method. The format and symbols employed are provided to explain the logical steps of the method and do not limit the scope of the method. Additionally, the order in which a particular method occurs may or may not strictly adhere to the order of the corresponding steps shown. For example, a plurality of stamping operations may be performed concurrently.

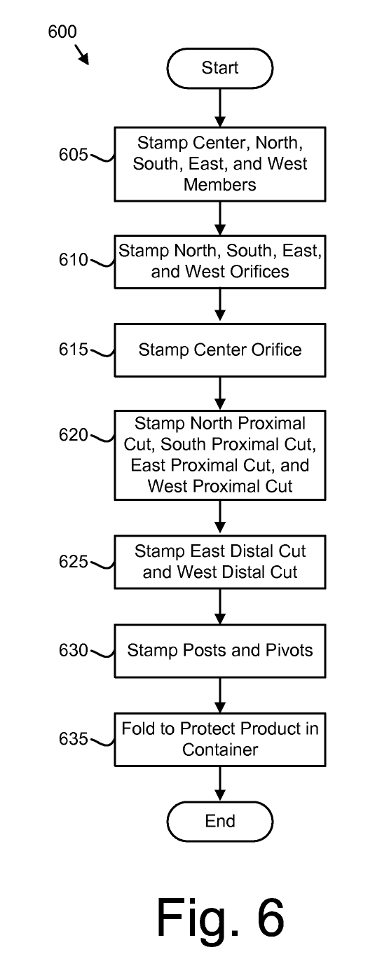

FIG. 6 is a schematic flow chart diagram illustrating one embodiment of a protection method 600 of the present invention. The method 600 substantially includes the steps to carry out the functions presented above with respect to the operation of the described apparatus and protected products of FIGS. 1-5. The described stamping operations may be carried out by one or more stamps, although for simplicity a single stamp is referenced.

The method 600 begins and a stamp stamps 605 the center member 105, the north member 110, the south member 115, the east member 120, and the west member 125 from a polyethylene sheet. The center member 105 is in physical communication with the bottom of the product 405. The north member 110, south member 115, east member 120, and west member 125 are in communication with the center member 105 and form a single apparatus 100, 200, 300.

In addition, the stamp stamps 610 the north orifice 130 in the north member 110, the south orifice 135 in the south member 115, the east orifice 140 in the east member 120, and the west orifice 145 in the west member 125. In one embodiment, the stamp stamps 615 the center orifice 205 in the center member 105.

The stamp further stamps 620 the north proximal cut 150 along the lower side of the sheet. The north member 110 is partially separated from the center member 105 and is configured to pivot upward to form at least a ninety degree angle to the center member 105 and physically communicate with the north side of the product 405. The stamp further stamps 620 the south proximal cut 155 along the lower side of the sheet. The south member 115 is partially separated from the center member 105 and is configured to pivot upward to form at least a ninety degree angle to the center member 105 and physically communicate with the south side of the product 405.

In addition, the stamp stamps 620 the east proximal cut 160 along the lower side of the sheet. The east member 120 is partially separated from the center member 105 and is configured to pivot upward to form at least a ninety degree angle to the center member 105 and physically communicate with the east side of the product 405. The stamp further stamps 620 the west proximal cut 165 along the lower side of the sheet. The west member 125 is partially separated from the center member 105 and is configured to pivot upward to form at least a ninety degree angle to the center member 105 and physically communicate with the west side of the product 405.

In one embodiment, the stamp stamps 625 the east distal cut 170 in the east member 120 that partially separates the east distal edge 180 from the east member 120 and permits the east distal edge 180 to pivot toward the center member 105 such that the east distal edge 180 is in physical communication with the top of the product 400 when folded. The stamp further stamps 625 the west distal cut 175 in the west member 125 that partially separates the west distal edge 185 from the west member 125 and permits the west distal edge 180 to pivot toward the center member 105 such that the west distal edge 185 is in physical communication with the top of the product 405 when folded.

In one embodiment, the east distal cut 170 comprises a north east distal cut 170a and a south east distal cut 170b. The west distal cut 175 may comprise a north west distal cut 175a and a south west distal cut 175b.

The stamp may stamp 630 posts 335, 340 and pivots 315, 320 by stamping the east divisional cut 305 that separates the east distal edge 180 from the east member 120 between the north east distal cut 170a and the south east distal cut 170b. In addition, the stamp may stamp 630 the west divisional cut 310 that separates the west distal edge 185 from the west member 125 between the north west distal cut 175a and the south west distal cut 175b.

The east distal edge 180 may comprise the south east edge pivot 315b extending east from the south east distal cut 170b, the north east edge pivot 315a extending east from the north distal cut 170a, and the east cross member 325 physically communicating between the south east edge pivot 315b and the north east edge pivot 315a. The east divisional cut 305 extends east from a terminus of the south east distal cut 170b to the east cross member 325, north along the east cross member 325, and west to a terminus of the north east distal cut 170a.

The east member 120 may further comprise a north east post 335a disposed between the east orifice 140 and the east divisional cut 305 and a south east post 335b disposed between the east orifice 140 and the east divisional cut 305. The distal end of the north east post 335a and the distal end of the south east post 335b are each coplanar with a face of the east distal edge 180 when folded.

The west distal edge 185 may comprise the south west edge pivot 320b extending west from the south west distal cut 175b, the north west edge pivot 320a extending west from the north distal cut 175a, and the west cross member 330 physically communicating between the south west edge pivot 320b and the north west edge pivot 320a. The west divisional cut 310 may extend west from a terminus of the south west distal cut 175b to the west cross member 330, north along the west cross member 330, and west to a terminus of the north west distal cut 175a.

The west member 125 may further comprise the north west post 340a disposed between the west orifice 145 and the west divisional cut 310 and the south west post 340b disposed between the west orifice 140 and the west divisional cut 310. The distal end of the north west post 340a and the distal end of the south west post 340b may each be coplanar with a face of the west distal edge 185 when folded. A packaging device and/or production worker may fold 635 the north member 110, south member 115, east member 120, and west member 125 about the product 405 to protect the product 405 in the container 505.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus fabricated from a single planar foam sheet, the apparatus:
comprising:
a center member in physical communication with a bottom of the product;
a north member in communication with the center member and comprising a north orifice, the north member partially separated from the center member by a north proximal cut along a lower side of the sheet wherein the north member is configured to pivot upward to form at least a ninety degree angle to the center member and physically communicate with a north side of a product;
a south member in communication with the center member and comprising a south orifice, the south member partially separated from the center member by a south proximal cut along the lower side of the sheet wherein the south member is configured to pivot upward to form at least a ninety degree angle to the center member and physically communicate with a south side of the product;
an east member in communication with the center member and comprising an east orifice, the east member partially separated from the center member by an east proximal cut along the lower side of the sheet wherein the east member is configured to pivot upward to form at least a ninety degree angle to the center member and physically communicate with an east side of the product, the east member further comprising an east distal cut that partially separates an east distal edge from the east member and permits the east distal edge to pivot toward the center member such that the east distal edge is in physical communication with a top of the product when folded; and
a west member in communication with the center member and comprising a west orifice, the west member partially separated from the center member by a west proximal cut along a lower side of the sheet wherein the west member is configured to pivot upward to form at least a ninety degree angle to the center member and physically communicate with a west side of the product, the west member further comprising a west distal cut that partially separates a west distal edge from the west member and permits the west distal edge to pivot toward the center member such that the west distal edge is in physical communication with the top of the product when folded.

2. The apparatus of claim 1, wherein a distance from the east proximal cut to the east distal cut is substantially equivalent to a height of the east side of the product and a distance from the west proximal cut to the west distal cut is substantially equivalent to a height of the west side of the product.

3. The apparatus of claim 1, wherein the east distal cut comprises a north east distal cut and a south east distal cut and the east member further comprises an east divisional cut that separates the east distal edge from the east member between the north east distal cut and the south east distal cut.

4. The apparatus of claim 3, wherein the east distal edge comprises a south east edge pivot extending east from the south east distal cut, a north east edge pivot extending east from the north distal cut, and an east cross member physically communicating between the south east edge pivot and the north east edge pivot, wherein the east divisional cut extends east from a terminus of the south east distal cut to the east cross member, north along the east cross member, and west to a terminus of the north east distal cut.

5. The apparatus of claim 4, wherein the east member further comprises a north east post disposed between the east orifice and the east divisional cut and a south east post disposed between the east orifice and the east divisional cut, wherein a distal end of the north east post and a distal end of the south east post are each coplanar with a face of the east distal edge when folded.

6. The apparatus of claim 5, wherein the west distal cut comprises a north west distal cut and a south west distal cut and the west member further comprises a west divisional cut that separates the west distal edge from the west member between the north west distal cut and the south west distal cut.

7. The apparatus of claim 6, wherein the west distal edge comprises a south west edge pivot extending west from the south west distal cut, a north west edge pivot extending west from the north distal cut, and a west cross member physically communicating between the south west edge pivot and the north west edge pivot, wherein the west divisional cut extends west from a terminus of the south west distal cut to the west cross member, north along the west cross member, and west to a terminus of the north west distal cut.

8. The apparatus of claim 7, wherein the west member further comprises a north west post disposed between the west orifice and the west divisional cut and a south west post disposed between the west orifice and the west divisional cut, wherein a distal end of the north west post and a distal end of the south west post are each coplanar with a face of the west distal edge when folded.

9. The apparatus of claim 1, wherein the north, south, east, and west orifices extend outward from the center member.

10. The apparatus of claim 1, wherein the north, south, east, and west orifices are cut from an area in the range of fifteen percent to forty percent of an area of the north, south, east, and west members respectively.

11. The apparatus of claim 1, the center member further comprising a center orifice.

12. The apparatus of claim 11, wherein the center orifice is cut from an area in the range of fifteen percent to forty percent of an area of the center member.

13. A system comprising:
a container;
a foam cushion configured to protect the product with the container, the foam cushion fabricated from a single planar sheet and comprising
a center member in physical communication with a bottom of a product;
a north member in communication with the center member and comprising a north orifice, the north member partially separated from the center member by a north proximal cut along a lower side of the sheet wherein the north member is configured to pivot upward to form at least a ninety degree angle to the center member and physically communicate with a north side of the product;
a south member in communication with the center member and comprising a south orifice, the south member partially separated from the center member by a south proximal cut along the lower side of the sheet wherein the south member is configured to pivot upward to form at least a ninety degree angle to the center member and physically communicate with a south side of the product;
an east member in communication with the center member and comprising an east orifice, the east member partially separated from the center member by an east proximal cut along the lower side of the sheet wherein the east member is configured to pivot upward to form at least a ninety degree angle to the center member and physically communicate with an east side of the product, the east member further comprising an east distal cut that partially separates an east distal edge from the east member and permits the east distal edge to pivot toward the center member such that the east distal edge is in physical communication with a top of the product when folded; and
a west member in communication with the center member and comprising a west orifice, the west member partially separated from the center member by a west proximal cut along the lower side of the sheet wherein the west member is configured to pivot upward to form at least a ninety degree angle to the center member and physically communicate with a west side of the product, the west member further comprising a west distal cut that partially separates a west distal edge from the west member and permits the west distal edge to pivot toward the center member such that the west distal edge is in physical communication with the top of the product when fold and the foam cushion and product disposed within the container.

14. The system of claim 13, wherein:
a distance from the east proximal cut to the east distal cut is substantially equivalent to a width of the east side of the product;
a distance from the west proximal cut to the west distal cut is substantially equivalent to a width of the west side of the product;
the east distal cut comprises a north east distal cut and a south east distal cut;
the east member further comprises an east divisional cut that separates the east distal edge from the east member between the north east distal cut and the south east distal cut;
the east distal edge comprises a south east edge pivot extending east from the south east distal cut, a north east edge pivot extending east from the north distal cut, and an east cross member physically communicating between the south east edge pivot and the north east edge pivot, the east divisional cut extending east from a terminus of the south east distal cut to the east cross member, north along the east cross member, and west to a terminus of the north east distal cut; and
the east member further comprises a north east post disposed between the east orifice and the east divisional cut and a south east post disposed between the east orifice and the east divisional cut, wherein a distal end of the north east post and a distal end of the south east post are each coplanar with a face of the east distal edge when folded.

15. The system of claim 15, wherein:
the west distal cut comprises a north west distal cut and a south west distal cut;
the west member further comprises a west divisional cut that separates the west distal edge from the west member between the north west distal cut and the south west distal cut;
the west distal edge comprises a south west edge pivot extending west from the south west distal cut, a north west edge pivot extending west from the north distal cut, and a west cross member physically communicating between the south west edge pivot and the north west edge pivot, the west divisional cut extending west from a terminus of the south west distal cut to the west cross member, north along the west cross member, and west to a terminus of the north west distal cut;
the west member further comprises a north west post disposed between the west orifice and the west divisional cut and a south west post disposed between the west orifice and the west divisional cut, wherein a distal end of the north west post and a distal end of the south west post are each coplanar with a face of the west distal edge when folded.

16. A method comprising:
stamping a center member from a polyethylene sheet, the center member in physical communication with a bottom of a product, a north member in communication with the center member, a south member in communication with the center member, an east member in communication with the center member, and a west member in communication with the center member;
stamping a north orifice in the north member, a south orifice in the south member, an east orifice in the east member, and a west orifice in the west member;
stamping a north proximal cut along a lower side of the sheet wherein the north member is partially separated from the center member and is configured to pivot upward to form at least a ninety degree angle to the center member and physically communicate with a north side of the product, a south proximal cut along the lower side of the sheet wherein the south member is partially separated from the center member and is configured to pivot upward to form at least a ninety degree angle to the center member and physically communicate with a south side of the product, an east proximal cut along the lower side of the sheet wherein the east member is partially separated from the center member and is configured to pivot upward to form at least a ninety degree angle to the center member and physically communicate with an east side of the product, and a west proximal cut along the lower side of the sheet wherein the west member is partially separated from the center member and is configured to pivot upward to form at least a ninety degree angle to the center member and physically communicate with a west side of the product; and
stamping an east distal cut in the east member that partially separates an east distal edge from the east member and permits the east distal edge to pivot toward the center member such that the east distal edge is in physical communication with a top of the product when folded and a west distal cut in the west member that partially separates a west distal edge from the west member and permits the west distal edge to pivot toward the center member such that the west distal edge is in physical communication with the top of the product when folded.

17. The method of claim 16, wherein:
the east distal cut comprises a north east distal cut and a south east distal cut and the method further comprises stamping an east divisional cut that separates the east distal edge from the east member between the north east distal cut and the south east distal cut;
the east distal edge comprises a south east edge pivot extending east from the south east distal cut, a north east edge pivot extending east from the north distal cut, and an east cross member physically communicating between the south east edge pivot and the north east edge pivot, wherein the east divisional cut extends east from a terminus of the south east distal cut to the east cross member, north along the east cross member, and west to a terminus of the north east distal cut;
the east member further comprises a north east post disposed between the east orifice and the east divisional cut and a south east post disposed between the east orifice and the east divisional cut, wherein a distal end of the north east post and a distal end of the south east post are each coplanar with a face of the east distal edge when folded;
the west distal cut comprises a north west distal cut and a south west distal cut and the method further comprises stamping a west divisional cut that separates the west distal edge from the west member between the north west distal cut and the south west distal cut;
the west distal edge comprises a south west edge pivot extending west from the south west distal cut, a north west edge pivot extending west from the north distal cut, and a west cross member physically communicating between the south west edge pivot and the north west edge pivot, wherein the west divisional cut extends west from a terminus of the south west distal cut to the west cross member, north along the west cross member, and west to a terminus of the north west distal cut; and
the west member further comprises a north west post disposed between the west orifice and the west divisional cut and a south west post disposed between the west orifice and the west divisional cut, wherein a distal end of the north west post and a distal end of the south west post are each coplanar with a face of the west distal edge when folded.

18. The method of claim 17, further comprising stamping a center orifice in the center member.

19. The method of claim 18, the method further comprising folding the north, south, east, and west members about the product to protect the product in a container.

20. An apparatus comprising:
means for communicating with a bottom of a product formed from a single polyethylene sheet;
means for communicating with a north side of the product formed from the polyethylene sheet, the north communicating means in communication with the bottom communicating means and comprising a north orifice, the north communicating means partially separated from the bottom communicating means by a north proximal cut along a lower side of the polyethylene sheet wherein the north communicating means is configured to pivot upward to form at least a ninety degree angle to the bottom communicating means;
means for communicating with a south side of the product formed from the polyethylene sheet, the south communicating means in communication with the bottom communicating means and comprising a south orifice, the south communicating means partially separated from the bottom communicating means by a south proximal cut along the lower side of the polyethylene sheet wherein the south communicating means is configured to pivot upward to form at least a ninety degree angle to the bottom communicating means;
means for communicating with an east side of the product formed from the polyethylene sheet, the east communicating means in communication with the bottom communicating means and comprising an east orifice, the east communicating means partially separated from the bottom communicating means by an east proximal cut along the lower side of the polyethylene sheet wherein the east communicating means is configured to pivot upward to form at least a ninety degree angle to the bottom communication means, the east communicating means further comprising an east distal cut that partially separates an east distal edge from the east communicating means and permits the east distal edge to pivot toward the bottom communicating means such that the east distal edge is in physical communication with a top of the product when folded; and
means for communicating with a west side of the product formed from the polyethylene sheet, the west communicating means in communication with the center member and comprising a west orifice, the west member partially separated from the bottom communicating means by a west proximal cut along the lower side of the polyethylene sheet wherein the west communicating means is configured to pivot upward to form at least a ninety degree angle to the bottom communicating means, the west communicating means further comprising a west distal cut that partially separates a west distal edge from the west communicating means and permits the west distal edge to pivot toward the bottom communicating means such that the west distal edge is in physical communication with the top of the product when folded.
